(19) United States
(12) Patent Application Publication
(10) Pub. No.: US 2012/0247504 A1
(43) Pub. Date: Oct. 4, 2012

(54) System and Method for Sub-micron Level Cleaning of Surfaces

(76) Inventors: Waleed Nasr, Valencia, CA (US); Khaled Nasr, Los Angeles, CA (US)

(21) Appl. No.: 13/072,555

(22) Filed: Mar. 25, 2011

Related U.S. Application Data
(63) Continuation-in-part of application No. 12/896,434, filed on Oct. 1, 2010.

(51) Int. Cl. B08B 7/04; B08B 13/00

(52) U.S. Cl. 134/1.1; 156/345.5

(57) ABSTRACT

An apparatus is used for removing contaminants from a surface and includes a chamber filled with a clean process gas, a surface positioning device, a carbon dioxide snow spray nozzle, a laser beam generator and focusing device and a process gas nozzle. The nozzles and a focal point of the laser beam are linearly aligned. The surface is held at a desired position and bombarded with carbon dioxide snow and with a high pressure wave to release the contaminants from the surface whereupon the released materials are swept to one side of the surface by a jet of the process gas. The process may proceed with point to point contamination removal based on prior surface examination and discovery of contamination sites, or may be scanned with essentially continuous contamination removal.

This application is a continuation-in-part of currently pending U.S. non-provisional patent application Ser. No. 12/896,434 filed on Oct. 1, 2010 and which is hereby incorporated by reference herein in its entirety.

### TECHNICAL FIELD AND BACKGROUND

Surfaces such as those of photomasks, semiconductor wafers, and optical elements associated with, for instance, printing microelectronic features, are susceptible to the adhesion of contaminants formed during processing. Such contaminants typically include: particles, haze, crystal growth, ionic residues, and oxides, among others. This disclosure relates to novel systems and methods for the removal of such contaminants down to the sub-micron level for producing ultra-clean surfaces and achieving drastic improvements in manufacturing yields.

There are currently numerous methods used in the field of this disclosure to remove contaminants from substrate surfaces including both chemical and mechanical cleaning techniques. For example, wet cleaning, megasonic and ultrasonic cleaning, brush cleaning, supercritical fluid cleaning, and wet laser cleaning are all used to clean the surface of a substrate. However, for sub-micron sized contaminates these cleaning processes are ineffective as each has serious drawbacks requiring the use of cleaning tools and chemical agents that may introduce new contaminates or which may damage critical dimensions of a semiconductor or mask device. Furthermore, each of the above cleaning processes is directed to cleaning the entire surface of a substrate at one time thereby increasing the possibility of contaminant redeposition and producing substrate surface damage.

In conventional cleaning of substrates, a wet cleaning method commonly referred to by the term “RCA cleaning” uses large-scale multi-tank immersion cleaning units. This procedure has been used for many years. In this technique, up to 50 substrates are immersed sequentially in aqueous solutions of: ammonium hydroxide plus hydrogen peroxide, hydrochloric acid plus hydrogen peroxide, and dilute heated hydrofluoric acid so as to remove contaminants. After each chemical processing step, the substrates are rinsed in pure water. Since this process uses a large amount of environmentally undesirable and expensive chemicals, and is not especially effective for smaller contaminants, alternative cleaning approaches are needed.

Wet laser cleaning is also used to clean a substrate surface. This cleaning technique uses a liquid, such as water or water and alcohol, wherein the solution is super-heated using a laser pulse as the heat source. In so doing, the solution rapidly expands propelling contaminants off the substrate surface. In this approach, the liquid solution can penetrate and lift patterned metal lines thereby causing damage to a pattern and generating particulate.

Other cleaning techniques include those that employ momentum transfer as a means to impinge and dislodge contaminants from a surface. For example cryogenic aerosol cleaning uses pressurized frozen particles to remove surface contamination. Momentum transfer cleaning techniques are problematic for semiconductor technology as they leave hydrocarbon particles behind on the cleaned surface. This is primarily due to the purity of the CO2 that is commercially available. These particles range in size from about 90 to up to 250 nm and are easily detected by available inspection systems.

As the size of the features of semiconductors decreases, the need for, and cost of removal of substrate contamination tends to increase. A more effective and efficient cleaning method and apparatus for removing contaminants from semiconductor and optics industry work products is needed.

### SUMMARY

The presently described apparatus and method provides a novel and greatly improved means for removing sub-micron contamination from critical surfaces. The method employs a carbon dioxide snow jet directed at contamination sites or scanned over the entire substrate surface and also a non-contact laser induced plasma shockwave also directed to such sites or scanned forming overlapping sites.

The apparatus includes a laser shockwave cleaning station and a carbon dioxide jet spray station both disposed within an environmental cleaning system that processes semiconductor wafers, photomasks, and other articles that require an ultra-clean surface. The processing system also includes computer controlled mechanical apparatus to handle the substrates to and from the cleaning stations. The substrates are handled within a clean environment in an inner chamber positioned within an outer chamber so as to avoid cross contamination. A process gas injection system produces fluid currents that drive loosened and released contaminants off the substrate so that they are not redeposited.

The laser shockwave cleaning station provides a novel and greatly improved means for removing sub-micron metallic, inorganic and organic particulate contamination from critical surfaces. The method employs a laser beam focused at a selected point in the gaseous environment above the work piece which results in a dielectric breakdown and ionization of the gas thereby generating a rapidly expanding plasma at the focal point of the laser beam. Initially a release of electrons occurs due to the collision of photons with gas molecules. This creates localized high pressure plasma forming a shock wave which moves outward at supersonic velocity. With a Nd:YAG pulsed laser, these actions occur approximately in the first 100-150 ns of the arrival of the laser pulse at the focal point. The shock wave separates from the plasma within the first few microseconds of the process and travels to impact the substrate surface thereby loosening and releasing contaminants. The shock wave plays a critical role in breaking the bonds which hold particles to a substrate. A force moment is exerted on the particles due to collisions between adjacent gas molecules and the particles. This results in delivering energy to the particles causing them to be loosened. This interaction is a momentum transfer process which results in agitation and detachment of the particles from the substrate when the agitation forces exceed the adhesion forces.

The laser-induced plasma also plays an important role in removing hydrocarbon surface contamination, Ionization generates UV light, electrons, ions and metastable atoms. These factors remove hydrocarbon surface contamination by physical and chemical sputtering and repeated shockwave impact. Further discussions of physical and chemical sputtering as well as metastable atoms for the removal and desorption of hydrocarbon surface contamination can be found in “Removal of Carbon and Nanoparticles from Lithographic Materials by Plasma Assisted Cleaning by Metastable Atom Neutralization (PACMAN),” SPIE Vol. 7636 Part One, 76360O-1-76360O-11; “Swift chemical sputtering of covalently bonded materials,” Pure Appl. Chem., Vol. 78, No. 6, pp. 1203-1211, 2006. “Observation of H+ desorption simulated by the impact of metastable helium atoms,” Surface Science 454(1-2), pp. 300-304, 2000,

The carbon dioxide jet spray station produces a carbon dioxide snow. The removal of organic and particulate contamination from surfaces during CO2 snow cleaning can be explained by two different mechanisms, one for particulate removal, and the other for organic contamination removal. The mechanism for particle removal involves a combination of forces related to a moving high velocity gas and momentum transfer between the snow particles and surface contamination particles. The mechanism for organic contamination removal requires the presence of a liquid carbon dioxide phase. The impact provides a transfer of momentum between the snow and surface contaminant and this transfer of momentum can overcome the surface adhesive forces. Once liberated from the surface, contaminants are easily carried away with a high velocity laterally moving gas stream. The jet spray nozzle is connected by a manifold to a liquid carbon dioxide tank that supplies purified liquid carbon dioxide to the jet spray nozzle. An ultra-high purity, high pressure, diaphragm valve, such as Swagelok model number 6LVV-DPI-IMR4, allows the flow of CO₂ from the source to the nozzle. Nozzles for carbon dioxide cleaning involve a single or expansion nozzle with one or multiple orifices. Effective single expansion nozzles are variations on the venturi orifice design with the exit size usually being elongated with respect to the input side. The orifice size can range from 0.003 inch to 0.008 inch. For submicron particle removal a fine CO₂ stream is required, and therefore a 0.003 inch orifice is used. Further discussions of CO₂ snow cleaning can be found in “Fundamentals and applications of dry CO₂ cryogenic aerosol for photomask cleaning,” Proc. of SPIE Vol. 7823 78232Y-7, “Carbon Dioxide Snow Cleaning—The Next Generation of Clean,” Precision Cleaning '95 Proceedings, “Dynamic modeling and simulation of a cryogenic carbon dioxide cleaning process,” Proc. IMechE Vol. 224 Part E: J. Process Mechanical Engineering.

The presence of capillary forces and particle deformation significantly increases the adhesion force between particle and substrate. In order to increase the efficiency of particle detachment due to the laser induced shock wave cleaning, a recirculating minienvironment supplies filtered compressed dry air or inert gas and is used to advantage to desorb the substrate surface thereby reducing the capillary forces and related particle adhesion.

Bearing in mind the problems and deficiencies of the prior art particulate removal processes, it is therefore an object of the presently described apparatus and method to provide improvements in contaminant removal from surfaces such as the substrate surfaces used in the manufacture of electronic components. A further objective is to use a carbon dioxide jet spray nozzle in removing organic contamination on substrate surfaces. Another objective is to provide a method and apparatus for using focused laser energy to create a shock wave for removing particles through a momentum transfer process. It is yet another objective to provide a method and apparatus to provide a gaseous sweep of the substrate surface to force removed particles to move away from the vicinity of the surface being cleaned. The use of CO2 snow jet in conjunction with shock wave blast in the manner described herein is considered to be a novel and non-obvious approach to the removal of particulate and organic substrate contamination in the sub-micron range.

The details of one or more embodiments of these concepts are set forth in the accompanying drawings and the description below. Other features, objects, and advantages of these concepts will be apparent from the description and drawings, and from the claims.

### DESCRIPTION OF DRAWINGS

FIG. 1 is a mechanical schematic diagram of an example of the system and method disclosed herein;

FIG. 2 is a further illustration of portions of the diagram of FIG. 1 with particular attention to a gaseous fluid sweep of a workpiece surface;

FIG. 3 is an example, in the form of a logic flow diagram, of a stepwise method of the present disclosure; and

FIG. 4 is an example graphical diagram of a scanning method of the present disclosure.

Like reference symbols in the various drawings indicate like elements.

### DETAILED DESCRIPTION

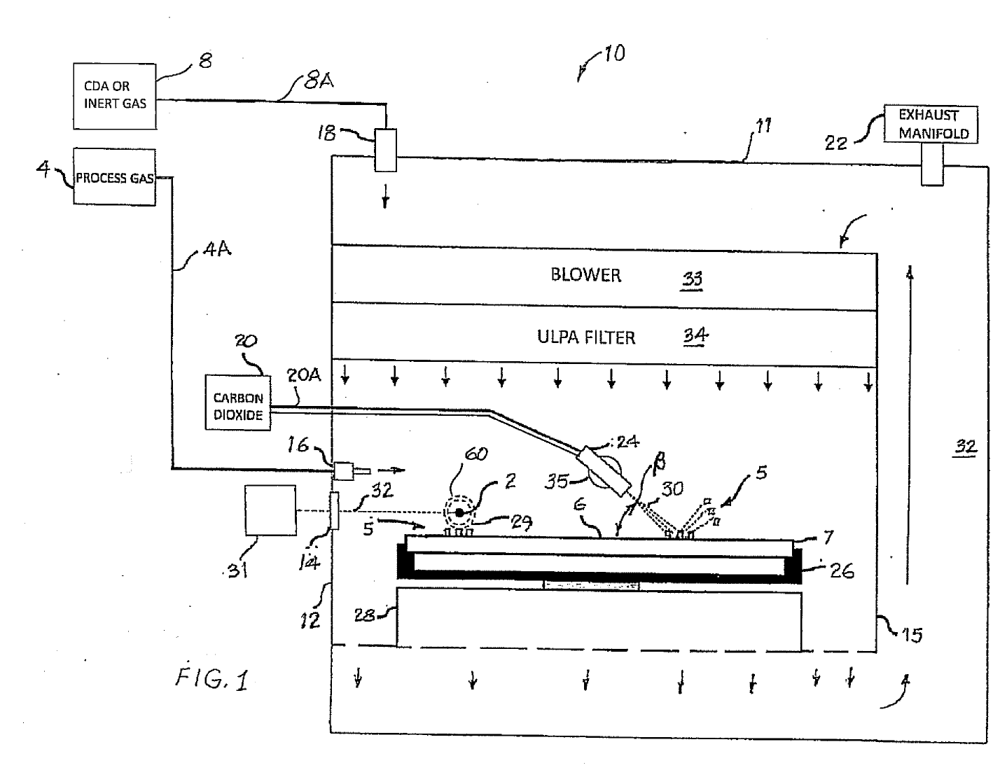

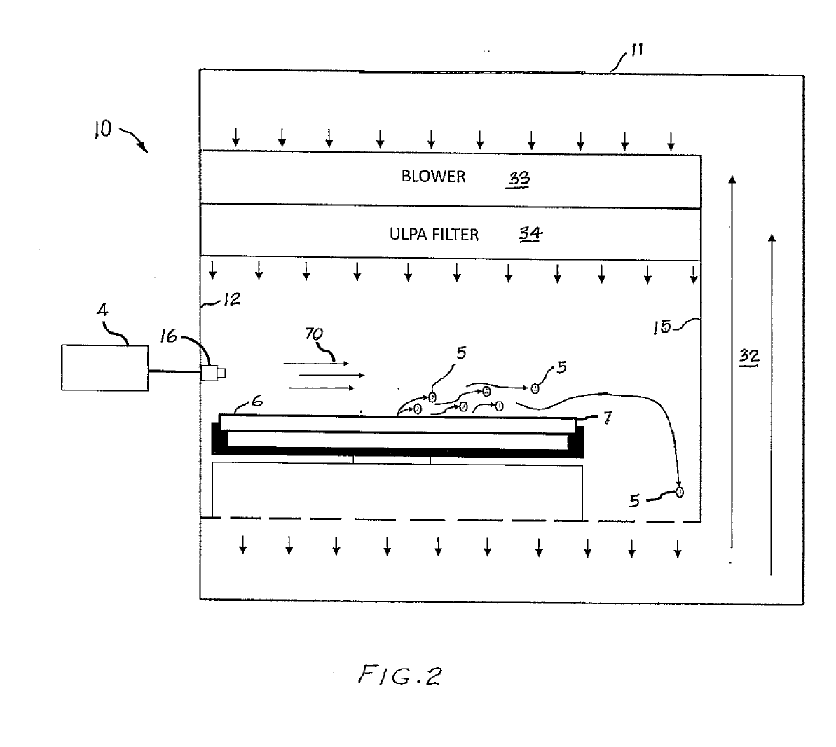

Described herein are a system 10 and a method of system operation for substrate surface cleaning at the submicron level. This system 10 and method is applicable to tools and work pieces that are required to be ultra-clean, such as those used in the fields of microcircuit fabrication, precision optics, medical arts, and related fields. As shown in FIG. 1, a substrate 7, the article to be cleaned, may be mounted on a motorized stage 28 such as a Newport Corporation, model number W98523A0, and may be held in place by a griping device 26 such as an edge clamp or a chuck as one provided by Semco, Inc., providing a means for mounting and manipulation that is well known in the field of semiconductor fabrication. The substrate 7 may be, for instance: a semiconductor wafer, a photomask, a precision optical element, or a similar article. The present system and method addresses substrates 7 that typically may require the removal of micro-particles and other materials that are strongly adherent to surfaces 6. In this description we refer to all such particles and other materials by the term contaminants 5. Substrate 7 may be made or coated with a material such as: quartz, metal, rubber, plastic, ceramic, or other substances. The surface 6 may be planar with surface roughness in the micrometer range, and may be able to be oriented, using stage 28, facing generally upwardly as is shown in FIGS. 1 and 2.

Contaminants 5 may be of any substance that is foreign to substrate 7 or foreign to the successful use of substrate 7 for its intended application, and may include, for instance, discrete solid bits of metals and non-metals, organic materials, dusts, miscellaneous debris, micro-droplets and residues therefrom, and other contaminants well known in the semiconductor fabrication and optics arts and related fields. The presently described method is applicable to contaminants 5 and agglomerations of contaminants 5 in the size range of a few nanometers to a few hundreds of nanometers. The contaminants 5 are typically secured or held to surfaces 6 by tenacious forces including mechanical, electrical and chemical bonds. Some of the contaminants 5 may be classified as organic contamination which may not be considered to be particulate related but are nonetheless addressed as such in the present disclosure.

The schematic illustration of FIG. 1 is an example of the presently described system 10, which is particularly well adapted for removing contaminants 5 from the substrates 7. The system 10 may include an outer chamber 11 within which is mounted an inner chamber 15. A common wall 12 of the two chambers 11 and 15 supports, or otherwise facilitates the use of an optical focusing lens 14, a first tubular conduit 20A, and a process gas injection nozzle 16. The first conduit 20A interconnects a source of carbon dioxide 20, in its liquid state, with a spray nozzle 24 which may be secured within chamber 15 in any well-known manner. Additionally, the walls of the outer chamber 11 support an inert gas inlet 18 and an exhaust manifold 22. The inert gas inlet 18 is interconnected with a source of an inert gas 8 by a second tubular conduit 8A. A source of a process gas 4 is interconnected by a third tubular conductor 4A with gas injection nozzle 16. Gases within the two chambers 11 and 15 may be expelled from outer chamber 11 through exhaust manifold 22. Inert gas 8 is ultra-pure, filtered to 0.003 micron, and enters into outer chamber 11 through inert gas inlet 18, and is then driven by a blower 33 through an ultra-low particulate air filter 34 into the inner chamber 15. The laminar flow fan filter unit may be provided by Envirco, inc., model number MAC-10. During processing, to be described below, process gas 4 flows across substrate 7 and is then drawn through a return channel 32 back to blower 33 and recycled. We have found that the best process gases 4 include inert gases such as: Ar, N2, and He admitted at a flow rate between 10-50 liters per minute. As shown in “Optical diagnostics for particle-cleaning processes utilizing laser-induced shockwaves,” Appl. Phys. A 79, 965-968 (2004), it is shown that the use of these process gases enhance the shockwave pressure and speed to effectively remove particles. Reactive gases such as H₂, O₂ and O₃ at a flow rate of 0.1-50 liters per minute may be used alone or in combination in the present method depending on the type of contaminant 5 that is to be removed. To remove hydrocarbon materials from the surface 6 He may be used to generate a shockwave as well as desorb and volatize the organic contamination. The foregoing is not an exhaustive listing of the types of process gas 4 that may be used in the presently described method. Chambers 11 and 15 may be operated under, at or near atmospheric pressure using inert gas 8 as a fill after evacuation of air from the chambers. A nitrogen purge may be used until the humidity level within the chambers reaches 1% RH so that capillary forces between particles 5 and surface 7 are reduced. The dry nitrogen purge is necessary to avoid the reactions between the oxygen in air and a reactive gas such as H₂. A dew point sensor, such as General Eastern model number MMY-35-R1-R1A may be used to control humidity level.

Referring still to FIG. 1, the previously mentioned substrate 7, chuck 26 and motorized stage 28 are positioned within the inner chamber 15 below the filter 34 and are therefore bathed by the ultra-clean inert gas 8 as is indicated by the arrows pointing downwardly from filter 34.

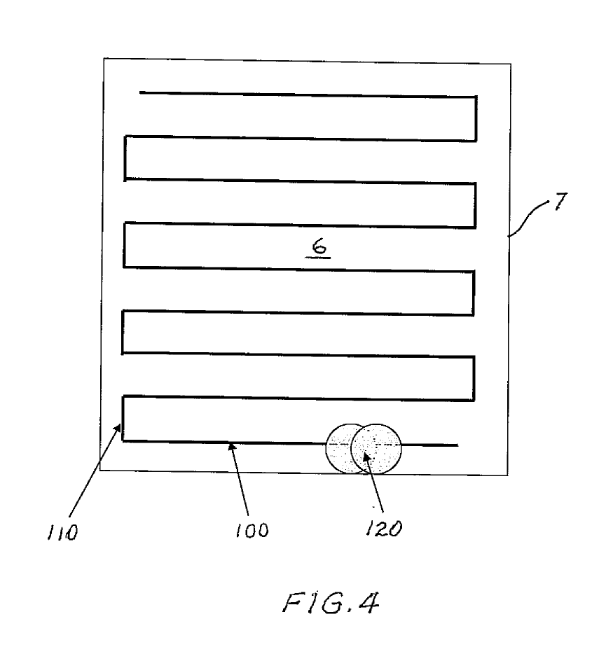

Referring again to FIG. 1, a micrometer adjuster such as Edmond Optics model number NT55-030 35 may be used to secure spray nozzle 24 in a selected fixed position above substrate 7 by any simple mechanical means, and may thereby set at a selected spray angle β relative to surface 6. Motorized X-Y-Z-β stage 28, is able to move as shown in FIG. 4, to allow spray 30 to access the entire surface of the substrate 6, or to target known locations on substrate 7. Fixture 35 may be any such simple mechanical holding and manipulating device and could be routinely selected by those of skill in the mechanical trades. FIG. 1 also shows that the apparatus includes a source of laser energy 31 such as a Q-switched Nd:Yag laser having a fundamental wavelength of approximately 1064 nm and appropriate optics for generating laser beam 32. The source of laser energy 31 may be mounted inside or outside chamber 15 in line with lens 14. A preferred configuration is to mount the laser energy source 32 outside the chamber, which reduces the tool footprint and reduces the possibility of particle contamination from this equipment.

### The Methods

Three critical but distinct techniques are jointly used in the present method for removing contaminants 5 from surface 6 and are referred to here by the general terms, “Snow,” “Shock,” and “Sweep.” None of these approaches is sufficient by themselves for achieving the desired objectives, but when used together, the result is superior to any cleaning approach known in the current technology. Both the Snow and the Shock techniques remove contaminants 5 from the surface 6 and may be initiated and terminated for each contaminant site within a finite time frame and each results in driving contaminants 5 away from surface 6 and into the gaseous environment above surface 6 by as much as 2 mm. This is confirmed in, “Visualization of particle trajectories in the laser shock cleaning process,” Appl Phys A (2008) 93: 147-151. The Snow, Shock, and Sweep techniques may be applied to specific pre-determined sites on surface 6 where it is known that contaminants 5 exist or to large areas at once, or in a selected continuous path. Thus, substrate 7 is manipulated to place each of the contaminant sites, in turn, at a position where the Snow and/or Shock technique can be effective.

Now, referring to FIG. 1, an example method of the Snow and Shock techniques will be described, and referring to FIG. 2, an example method of the Sweep technique will be described. In FIG. 1 the Snow and Shock techniques are shown to occur simultaneously but at different locations on surface 6, however, the Snow and Shock events may occur at the same location and may be simultaneous, nearly simultaneous, or sequential events. Each of the Snow and Shock events will have an effective spot size 120 on surface 6 (FIG. 4) having a diameter within which cleaning down to a selected sub-micron level is effective. To effectively clean contaminants larger than the effective laser shockwave 29 or snow stream 30 the motorized stage 28 moves the substrate 7 in a rectangular or circular pattern to cover the intended larger cleaning area. For example if a surface contaminant is 2 in² which is much larger then the shockwave 29 or snow stream 30 then the stage will move the substrate in an X-Y rectangular pattern that is, for example, 3 in². The larger rectangular cleaning area ensures that the entire target area is exposed to the laser shockwave and snow stream.

In the present approach of the Snow technique, a forceful jet stream of carbon dioxide snow impinges on the substrate at a contaminated site. The snow is produced by forceful ejection of the liquid carbon dioxide 20 out of nozzle 24. In the snow technique the LCO2 at a pressure of 850 psi emerges from nozzle 24 and evaporates immediately into a vapor in the form of a snow as described in “Carbon Dioxide Snow Cleaning-The Next Generation of Clean,” by Robert Sherman and Paul Adams. The snow has little mass, but has a relatively high kinetic energy which is delivered to contaminants 5 on surface 6. This technique is similar to the well-known dry-ice sweeping but without the destructive effect on the substrate surface 6. Delaminated contaminants 5 are rapidly projected away from surface 6 and move into the gaseous environment immediately adjacent to surface 6. Contaminant removal efficiency is enhanced when nozzle 24 is positioned at a selected acute angle β as shown in FIG. 1. An angular range of between 5 and 60 degrees relative to the plane of surface is effective. Through experimentation it has been discovered that the optimal angle and distance of the nozzle for removal of sub-micron surface contaminants is 5-10 degrees and 3-4 inches from the from the substrate surface. Since the Snow technique may leave behind hydrocarbon residue an additional contaminant removal step, such as the Shock technique, described next, is advantageously applied. Specific examples of cryogenic aerosol surface cleaning are disclosed in U.S. Pat. Nos. 5,315,793, 6,578,369 and 5,372,652.

In one procedure, The Shock technique is repeated, in turn, for each site on surface 6 where contaminants 5 have been previously identified. The source of laser energy 31 produces laser beam 32 which is directed through focusing lens 14 to focus at point 2 which is above a known contaminant site. The power density of the laser beam 32 at its focal point 2 is preferably about 10¹² W/cm2 which is enough power to ionize gases such as Air, Ar, N2 and He. The process gas 4 is rapidly ionized and heated causing its explosive expansion, i.e., a plasma shockwave 29. Shockwave 29 impinges on surface 6 thereby delaminating adhered contaminants 5 which are then propelled away from surface 6 by the kinetic energy delivered to them by the shockwave 29. The shockwave pressure is sufficient to remove micron and sub-micron contaminants from surface 6.

In the same procedure as described above a byproduct of the laser induced plasma shockwave 29 is the generation of ions and metastable atoms 60. The metastable atom bombardment extracts a bonding electron from the hydrogen-surface bond of the hydrocarbon contamination. This wakening of the hydrogen surface bond allows the hydrogen to desorb from the hydrocarbon contamination leaving behind carbon. Simultaneously ions bombard the carbon contamination physically removing it from the surface 6. The process of ion and metastable bombardment is related to chemical and physical sputtering.

As described above, both the Snow and the Shock techniques have the ability to remove contaminants 5 and to throw them up into the gaseous atmosphere adjacent to surface 6. As also previously noted, loosened, and removed contaminants 5 will tend to settle back onto surface 6 if not otherwise acted upon. As shown in FIG. 2, the Sweep technique causes contaminants 5, floating above surface 6, to move away from the substrate 7. Substrate 7 is positioned to one side and just below gas injection nozzle 16 which emits process gas 4 in a forceful stream 70 directed above, and which sweeps in parallel with and across, surface 6. This laterally moving strong flow of 28, 1 pm of process gas 4 moves over surface 6 imparting kinetic energy to the removed contaminants 5 so that they tend to move laterally (to the right in FIG. 2) and once clear of surface 6, the contaminants 5 tend to move with the general flow of gases within the inner chamber 15, that is, downwardly. Gaseous flow carries contaminants 5 so that they exit chamber 15 and then, drawn by blower 33 they move with gas flow upwardly through channel 32 where they are captured within filter 34. The gas stream 70 may be heated to about 80° C. to prevent condensation on surface 6.

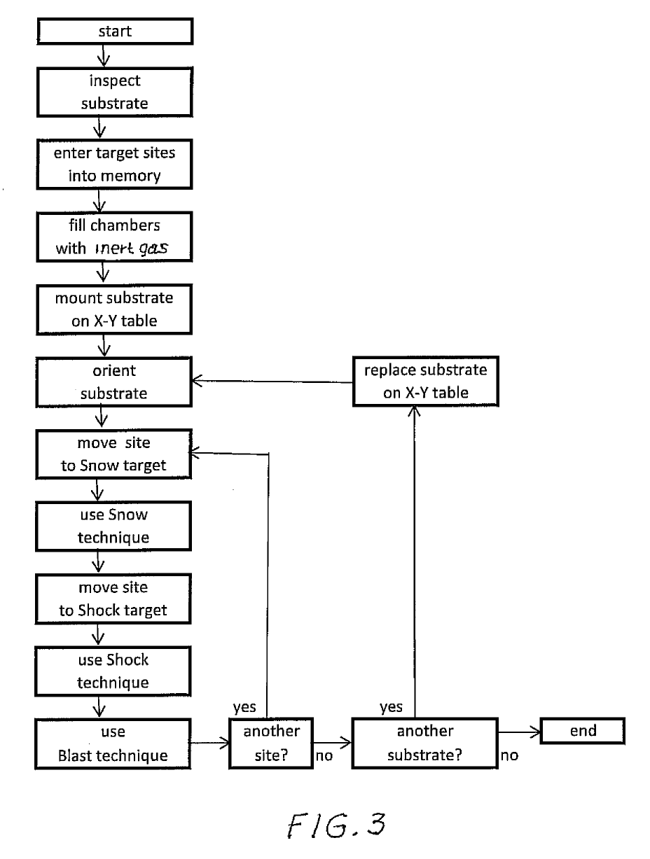

To summarize then, the Snow and the Shock techniques are each able to remove at least portions of contaminants 5 from surface 6. As stated, these two techniques may be used together, either serially or simultaneously, to remove contaminants 5 at previously discovered sites on surface 6. FIG. 3 illustrates an example of the present process. The ability to scan and identify the locations of contaminants 5 is well known in the art and could be applied to surface 6 as a routine step by those of skill in the field of the present disclosure. Once the X-Y coordinate locations of each contaminated site is known, the motorized stage 28 is able to move substrate 7 so as to position these locations sequentially for administration of the Snow and, or the Shock techniques and in conjunction with the Sweep technique. It should be clear that the Sweep nozzle 16, the focal point 2 of the laser beam 32, and the surface area where the snow spray 30 impacts, are mutually linearly aligned so that the Snow, Shock, and Sweep techniques may function synergistically with the released material of the contaminants 5 efficiently and effectively blown to one side of substrate 7. It should be clear also, that the elevation of surface 6 may be changed dynamically by stage 28 for optimizing the effectiveness of each of the Snow, Shock, and Sweep techniques. The preferred mode of the invention it that the height of the laser focal point may be 2 to 3.5 mm and the distance of the snow nozzle to the substrate surface 6 is between 3 to 4 inches. Finally, it is considered important to realize that the positioning of contaminants 5 with regard to the removal techniques described above are best suited to be coordinated and directed automatically by a computer 40. In this regard, an inspection of surface 6 and identification of the types and locations of contaminants 5 may be digitized and stored in the memory of such a computer 40 and then used to position the contaminants 5 appropriately for contaminant removal as described in detail above. Depending on the type of contaminants 5 such as: organic matter, metal particles, organic particles, mixtures of particle types, sizes, quantity and adhesive tenacity, the process sequence for removing contaminants 5 may be carried out selectively, as for instance, in one or another of the following sequences or in other sequences that are not shown:
Shock with Sweep
Shock with Snow with Sweep
Snow, followed by Shock with Sweep
Snow with Sweep, followed by Shock with Sweep
Snow with Sweep, Shock with Sweep, Snow with Sweep, Shock with Sweep

In one example, a photomask has inorganic sub-micron particles as well as hydrocarbon surface contamination. The Snow and the Shock techniques are utilized to remove the inorganic and organic contamination, such as C₈H₈, from the surface 6. For this example, these two techniques are used serially starting with CO₂ snow and followed by shockwave cleaning to remove the contaminants from the surface. The cleaning is accomplished by using purified liquid CO, from a cylinder at a pressure of 850 psi and 25 C. The liquid CO, is made to expand through a specially designed nozzle into a cleaning chamber held at atmospheric pressure. Expansion through the nozzle orifice and the subsequent Joule-Thomson cooling causes the CO, pressure and temperature to drop below the triple point. The phase point of CO, moves along the boundary between the solid and the vapor, thereby creating a mixture of liquid and gaseous CO, is directed in a focused stream. There are three mechanisms by which surface cleaning is accomplished: 1) momentum transfer by the cryogenic particles to overcome forces of adhesion, 2) drag force of gaseous CO₂, and 3) localized force due to sublimation of cryogenic particles accompanied by volume expansion.

The purity of CO2 has long been a problem for critical mask cleaning applications. The best commercially available supercritical fluid grades leave residues in the form of hydrocarbons which are typically detected by mask inspection systems. A subsequent laser shock cleaning procedures is required to remove the hydrocarbon particle adders left behind from the CO, snow process. The removal of hydrocarbon particles is conducted via exposure to a shockwave from the laser shock cleaning technique. With the Laser Shockwave Cleaning (LSC) procedure, particles are blasted away from the substrate by exposing them to the fast moving shockwave, resulting from laser induced breakdown (LIB) of Helium, or of another buffer gas, at a flow rate of approximately 28 1 pm. FIG. 1 shows the basic setup: a high-energy (100 mJ-2J), Q-switched laser pulse is directed parallel to the substrate surface and focused at about 3 mm above the surface. The intense focus produces a small plasma pocket that instantaneously expands generating the shockwave. The resulting shockwave removes the CO2 particle adders from the CO2 snow process.

In the same procedure as described above, a byproduct of the laser induced plasma shockwave in a helium gas is the generation of UV light, ions and He metastable atoms. The helium metastables have a long life and an energy of 19.82 eV for the triplet state and 20.616 eV for the singlet state, their interaction with the hydrocarbon surface is significant. As the helium metastable interacts with the hydrogen bond of the C₈H₈ hydrocarbon, the hydrogen is desorbed and the h-bonds are weakened. The combination of the weakened bonds from the metastable surface interaction and the energy imparted by the shockwave and ion and electron flux from the plasma, is the main removal mechanism of hydrocarbon surface contamination.

A spot cleaning technique uses a defect file from an inspection tool with the X-Y particle positions identified. Spot cleaning has been emphasized herein, but a complete cleaning of an entire surface may also be conducted which eliminates the need for inspection data. Local area cleaning was emphasized for the removal of post mask repair debris. This occasionally results in re-deposition of debris downstream of the cleaned areas. To enhance cleaning efficiency on, for instance, a photomask, a full mask area cleaning may be performed as illustrated in FIG. 4. This ensures that the photomask is completely clean of particles and debris rather than moving them from one area of the photomask to another. Full mask cleaning may be achieved by scanning an entire surface of a photomask in a serpentine pattern starting from one end of the photomask and finishing on the opposite end. Both full mask cleaning and spot cleaning are possible with the Shock and Snow processes but full mask cleaning is preferable. FIG. 4 shows an example of a series of parallel scanned linear paths 100 of the substrate 7 the linear paths ranging between 5-150 mm, connected by linear jogs having step sizes 110 the linear jogs 110 may range between 1-20 mm preferably 3 mm, and also shows the spot size 120, the spot size 120 is dependent on the laser power, the greater the power of the laser the larger the spot size. For example a 2-Joule laser with a 50-micron focal point can produce a spot size 120 of 2 cm. The substrate scanning speed, which may range between 1-20 mm/sec, preferably 5 mm/sec, step size 110 and effective spot size 120 determines the amount of overlapping of the cleaning process that can be accomplished. For example, with a spot size of 120 mm, the entire surface of a conventional photomask may be able to be cleaned without scanning at all. If the spot size 120 is 75 mm, one-half of a photomask can be cleaned with two passes, i.e., linear paths 100 connected by one jog.

A number of embodiments have been described, above. Nevertheless, it will be understood that various modifications may be made without departing from the spirit and scope of this disclosure. Accordingly, other embodiments are within the scope of the following claims.

What is claimed is:

1. An apparatus for removing contaminants from a surface positioned within a process gas within an inner chamber, the apparatus comprising:
a first nozzle positioned for directing a jet spray of carbon dioxide snow toward the contaminants, for releasing the contaminants from the surface;
a laser system enabled for focusing a laser beam at a laser beam focal point in the process gas adjacent to the contaminants, for releasing the contaminants from the surface;
a second nozzle positioned for directing a stream of the process gas across the surface, for driving released contaminants away from the surface; wherein
the first nozzle, laser beam focal point, and second nozzle are linearly aligned.

2. The apparatus for removing contaminants from a surface of claim 1, wherein the inner chamber is positioned within an outer chamber, the inner chamber fixtured for receiving the process gas in a laminar flow.

3. The apparatus for removing contaminants from a surface of claim 1, wherein the process gas is at least one of: Ar, Kr, N2, He, Ne, H2, O2, O3, NF3, C2F6, F2, and CL2 at near atmospheric pressure.

4. The apparatus for removing contaminants from a surface of claim 2, wherein the surface is on a substrate, the substrate held by a gripping device, the gripping device engaged with a motorized stage enabled for moving and positioning the surface.

5. The apparatus for removing contaminants from a surface of claim 2, further comprising a focusing lens mounted on a wall of the inner chamber.

6. The apparatus for removing contaminants from a surface of claim 1, wherein the first nozzle is adjustable over a range of angles.

7. The apparatus for removing contaminants from a surface of claim 4, wherein the motorized stage is enabled for moving the surface in steps and continuously over a selected path.

8. A method for removing contaminants from a surface, the method comprising at least two of Snow, Shock, and Sweep techniques, wherein the method is carried out along a selected path.

9. The method for removing contaminants from a surface of claim 8, wherein the Shock technique is used simultaneously with the Sweep technique.

10. The method for removing contaminants from a surface of claim 8, wherein the Snow technique is used simultaneously with the Sweep technique.

11. The method for removing contaminants from a surface of claim 8, wherein the Snow technique is used simultaneously with the Sweep technique followed immediately by the Shock technique used simultaneously with the Sweep technique.

12. The method for removing contaminants from a surface of claim 8, wherein the Snow technique is used simultaneously with the Sweep technique, followed by the Shock technique used simultaneously with the Sweep technique, followed by at least one further use of the Snow technique used simultaneously with the Sweep technique, and followed by the Shock technique used simultaneously with the Sweep technique.

13. A method for removing contaminants from a surface, the method comprising:
filling a chamber with a process gas scrubbed for particulate removal;
holding the surface at a selected position within the chamber;
bombarding the contaminants with a jet spray of carbon dioxide snow to release at least an initial portion of the contaminants from the surface; bombarding the contaminants with a high pressure wave of the process gas to release a further portion of the contaminants from the surface;
directing a stream of the process gas across the surface at the released portions of the contaminants thereby driving the released portions of the contaminants to one side of the surface.

14. The method for removing contaminants from a surface of claim 13, wherein the surface is held facing upwardly and the jet spray of carbon dioxide snow is directed at an angle relative to the surface.

15. The method for removing contaminants from a surface of claim 13, wherein the high pressure wave is generated by focusing a laser beam at a point in the process gas above the surface thereby rapidly ionizing a portion of the process gas.

16. The method for removing contaminants from a surface of claim 13, wherein the stream of the process gas is directed parallel to the surface and with enough force to drive released contaminants laterally across the surface.

17. The method for removing contaminants from a surface of claim 13, wherein the stream of the process gas is emitted from a nozzle on a linear path with the jet spray and also with an origin of the high pressure wave.

18. The method for removing contaminants from a surface of claim 13, wherein an inspection and coordinate identification of contaminant sites is stored in a computer memory and thereafter used to move the substrate into position for site by site application of the contaminant removal steps.

19. The method for removing contaminants from a surface of claim 13, wherein the jet spray of carbon dioxide snow is positioned at an angle of between 5 and 60 degrees relative to the surface.

20. The method for removing contaminants from a surface of claim 13, wherein the jet spray of carbon dioxide snow is positioned at an angle of 30 degrees relative to the surface.

21. The method for removing contaminants from a surface of claim 13, further comprising purging the chamber with a dry purge gas to reduce capillary forces between contaminants and the surface.
